(19) United States
(12) Patent Application Publication
(10) Pub. No.: US 2012/0221467 A1
(43) Pub. Date: Aug. 30, 2012

(54) MOBILE PAYMENT SYSTEM AND METHOD

(75) Inventors: MEHRAK HAMZEH, San Diego, CA (US); David Ide, San Diego, CA (US); Eddie Rodriguez, San Diego, CA (US); James P. Cleary, San Diego, CA (US)

(73) Assignee: Spindle, Inc., Scottsdale, AZ (US)

(21) Appl. No.: 13/338,110

(22) Filed: Dec. 27, 2011

Related U.S. Application Data
(60) Provisional application No. 61/427,435, filed on Dec. 27, 2010.

(51) Int. Cl. G06Q 20/16

(52) U.S. Cl. 705/40

(57) ABSTRACT

A mobile payment system and method are disclosed. A message is generated by, and received from, a first mobile device. The message includes a payment code, an amount of a payment, and a receiver designator representing a receiver of the payment. A confirmation message is then from the receiver of the payment. An amount of the payment and a fee is debited from a first account associated with the first mobile device. A second account associated with the receiver of the payment the amount of the payment is then credited. The message, and transaction, is a text message.

### CROSS REFERENCE TO RELATED APPLICATIONS

This application claims the benefit of priority under 35 U.S.C. §119 to U.S. Provisional Patent Application Ser. No. 61/427,435, filed on Dec. 27, 2010, entitled, “MOBILE PAYMENT SYSTEM AND METHOD”, the entire disclosures of which is incorporated by reference herein.

### BACKGROUND

This disclosure relates generally to mobile communications, and more particularly to a system and method for payment transactions through mobile messaging services.

Intelligent and multi-functional mobile communication devices, such as so-called smartphones like the Apple iPhone, the Droid phone, or modern Blackberry communication devices, are now ubiquitous for business or personal applications. However, the one area in which mobile devices have seen very little penetration is in the area of mobile banking, and more particularly with payments made using a mobile device. This is primarily due to security concerns and the difficulty in keeping the integrity of data that is transmitted to and from each mobile device. Secondarily, however no less a problem, many wireless networks have reliability issues, which puts further uncertainty on transactions executed by the mobile devices connected with these wireless networks. Furthermore, financial transactions require a high level of accuracy, and any platform executing such transactions needs to be robust, reliable, accurate and secure.

### SUMMARY

In general, this document discloses a mobile payment system and method that addresses conventional issues of security, data integrity, reliability and robustness.

In one aspect, a mobile payment system and method includes execution of a process. The process includes the step of receiving a message from a first mobile device, the message including a payment code, an amount of a payment, and a receiver designator representing a receiver of the payment. The process further includes receiving a confirmation message from the receiver of the payment, debiting, from a first account associated with the first mobile device, an amount of the payment and a fee. The process further includes the step of crediting a second account associated with the receiver of the payment the amount of the payment.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a mobile payment system.

FIGS. 2A-2N are screen shot representations of a website for registering and interacting with users of a mobile payment system.

FIGS. 3A-3D are flowcharts of methods for executing a person-to-person (P2P) mobile payment transaction.

FIG. 4 is a block diagram of a mobile commerce system.

FIG. 5 is a flowchart of a method for conducting mobile commerce in accordance with implementations described herein.

FIG. 6 is a block diagram of a mobile remittance system.

FIG. 7 is a block diagram of a customer web portal.

FIGS. 8-11 are flowcharts of various methods for conducting mobile commerce in accordance with implementations described herein.

Like reference symbols in the various drawings indicate like elements.

### DETAILED DESCRIPTION

This document describes a mobile payment system and method that can be used for person-to-person (P2P) payments, mobile commerce applications, mobile remittance using automated teller machines (ATMs), and mobile giving applications, among other uses. Users of the mobile payment system and method can sign up directly with the system, or can sign up through a registration program that is virally transmitted as a standalone invitation or along with a proposed payment or collection of a payment.

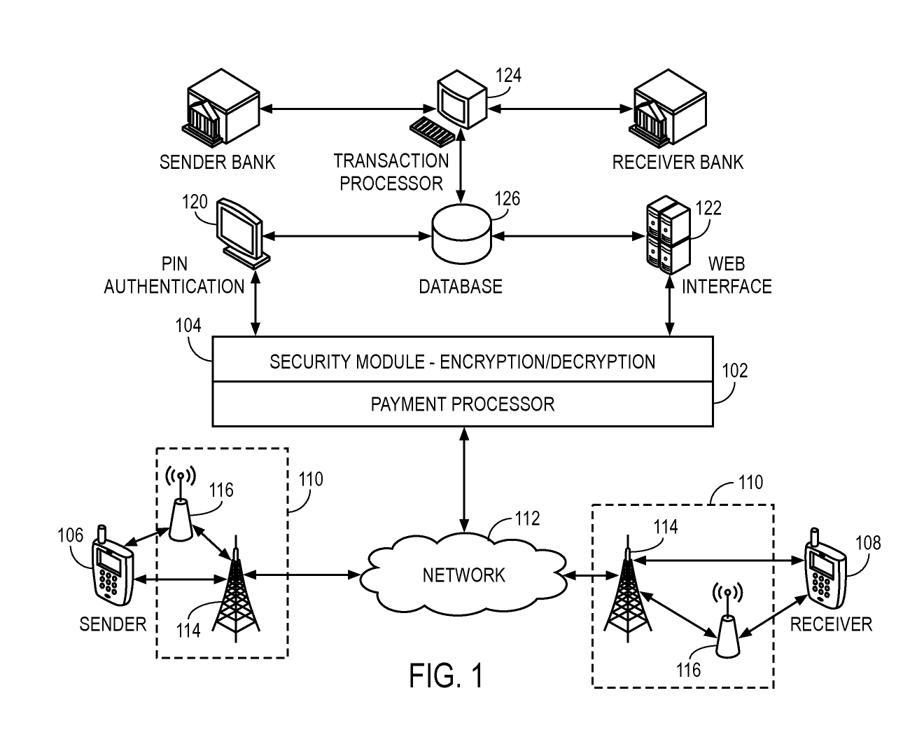

FIG. 1 is a block diagram of a mobile payment system 100. The system 100 includes a payment processing system 102 that includes payment processing software and logic and communication interfaces for executing mobile payment transactions. The payment processing system 102 provides a number of application programming interfaces (APIs) and logic modules for receiving messages from a network 104 and, based on the content of the messages, executing a payment transaction between a payment sender 106 and a payment receiver 108. As used herein, “sender” and “receiver” primarily refers to a mobile device or device communicating with a wireless network, but also to a user of such device.

The sender 106 is preferably a mobile communication device such as a cellular phone, a smart phone or any other mobile communication device that can transmit messages via a wireless network 110 and a ubiquitous communications network 112, such as the World Wide Web (i.e. “the Web”), also referred to herein as the “Internet”. The wireless network 110 may include any number of cellular towers/antennas 114 or wireless access points 116. The receiver 108 can be another mobile communications device, such as a cellular phone, smart phone, or other mobile communications device, or can be radio transmission device attached to an automated teller machine (ATM), a gas pump, a point-of-sale (POS) terminal, or other fixed terminal. In yet other implementations, the receiver 108 can be a computer terminal such as a desktop computer, laptop computer, a television, or any other Web communications-enabled computing device that can receive messages from the network 112 via wireless network 110.

The payment processing system 102 is connected with a security module 104 that performs encryption and decryption of messages between the sender 106, receiver 108 and the rest of the mobile payment system 100. The security module 104 may be hosted on a server connected with the network 112, and/or may be a local application or function on the sender 106 and/or receiver 108, or both. For instance, in preferred implementations, the messages sent by the sender 106 are short messaging service (SMS) messages, and the security module includes a local application to encrypt the SMS messages so that the content of the messages are not viewable by an unauthorized user of the sender 106 device.

The mobile payment system 100 further includes a personal identification number (PIN) authenticator 120, which authenticates any PINs that are entered by registered users of the payment processing system 102, and acting as either a sender or receiver of a payment. As will be explained in further detail below, users of the payment processing system 102 need to identify themselves and provide authentication of their identity. The PIN authenticator 120 can be a computer or a software module running on a computer. The mobile payment system 100 also includes a web interface 122 for communicating with the Web 112. The web interface 122 provides, among other functions, a web page from which users can register themselves to use the mobile payment system 100, or communicate with other potential users, or with any other component of the mobile payment system 100. In preferred exemplary implementations, the web interface 122 is implemented in a server environment, and is adapted for hypertext transfer protocol (HTTP or HTTPS) communications.

The mobile payment system 100 further includes a transaction processor 124, which executes the payment transaction between financial institutions, such as a sender bank and a receiver bank, associated with both the sender 106 and the receiver 108 of a payment, respectively. The transaction processor 124 can include, without limitation, an automated clearing house (ACH) function or network interface to execute electronic debit and credit payment transactions, such as electronic funds transfers (EFTs) or electronic bill payments (EBPs), represented by the messages between the sender 106 and the receiver 108.

The PIN authenticator 120, Web interface 122 and transaction processor 124 are connected to a database 126, which stores registration data for each user of the mobile payment system 100, as well as transaction history data for each mobile payment transaction executed by the payment processor 102. The database 126 can also store a history of messages between the sender 106 and receiver 108, whether or not related to a payment transaction. For instance, a receiver 108 may request payment from a sender 106 via a SMS message sent to the sender 106, and the sender 106 may decline the request via a reply SMS message. These messages between the receiver 108 and the sender 106 can be stored in the database 126 as a record of communication regarding the requested transaction.

Registration

Users can register to use the mobile payment system 100 by a sign-up process via the Web, WAP or SMS. New users provide their mobile telephone number.

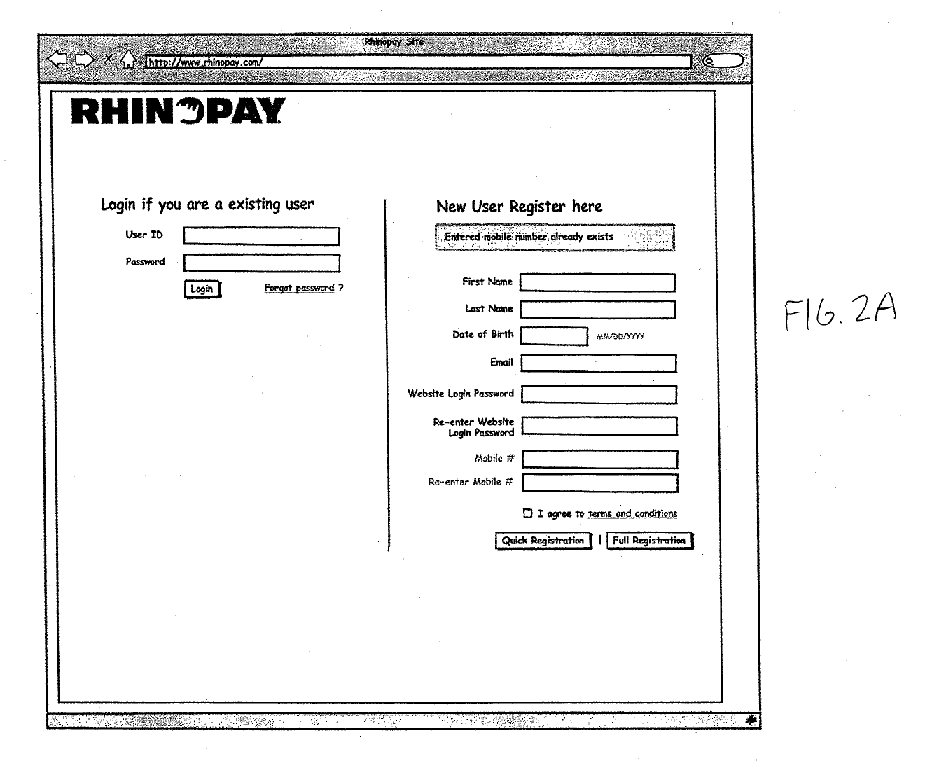

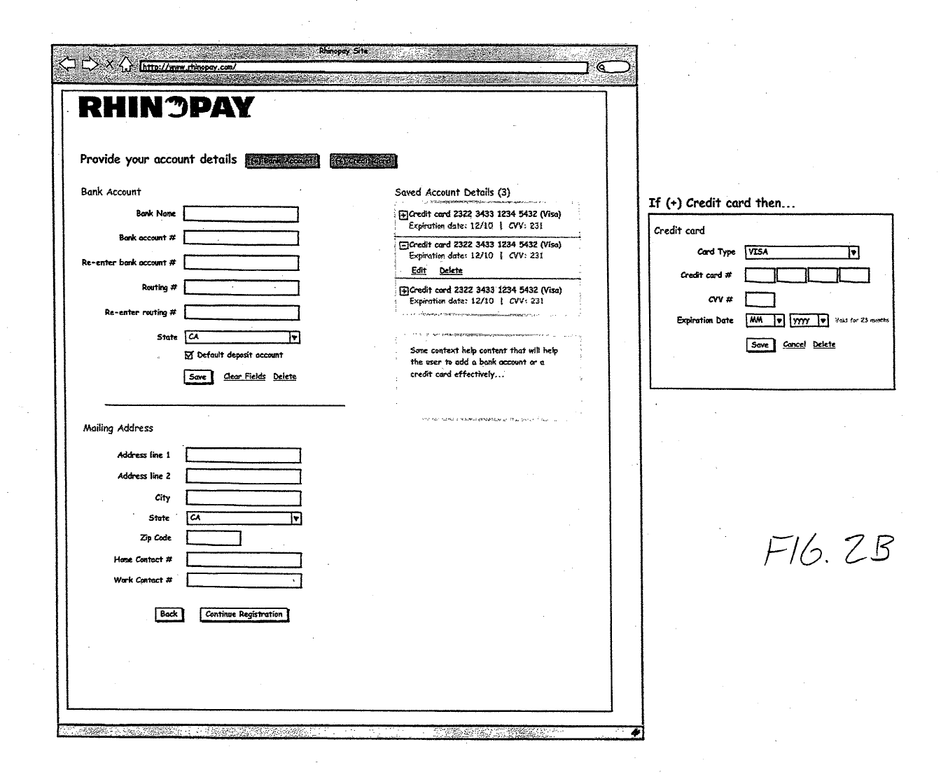

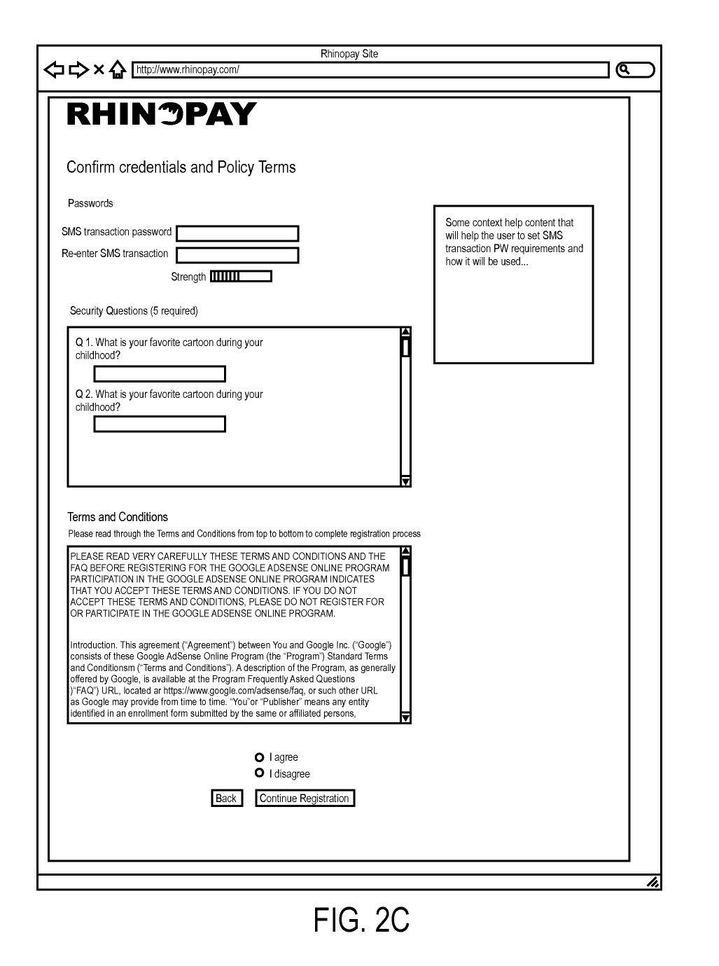

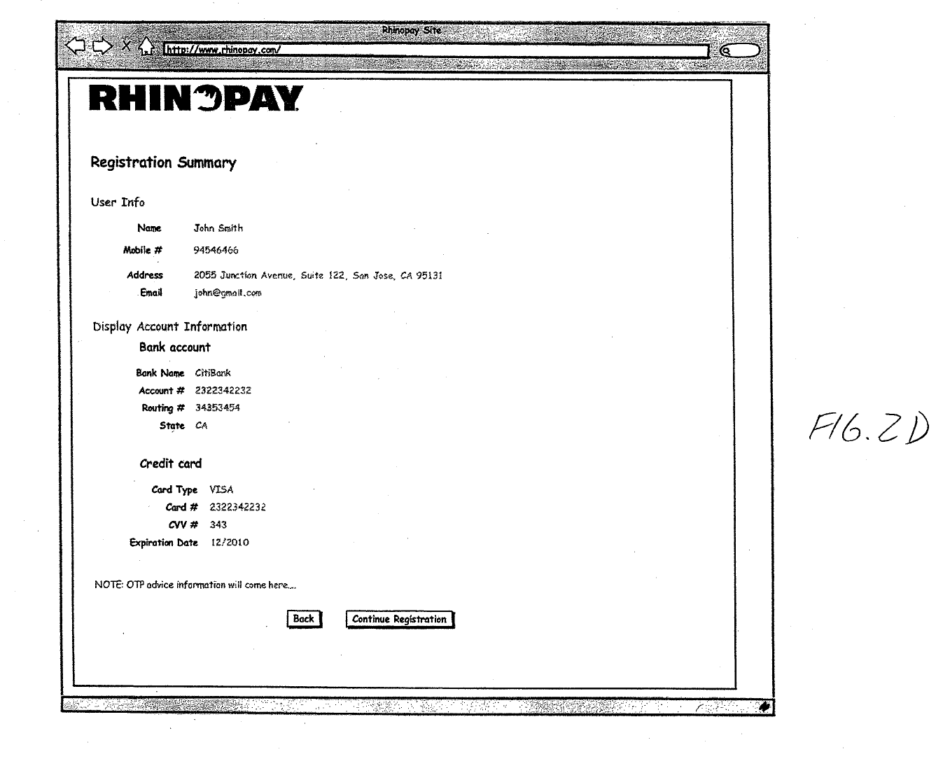

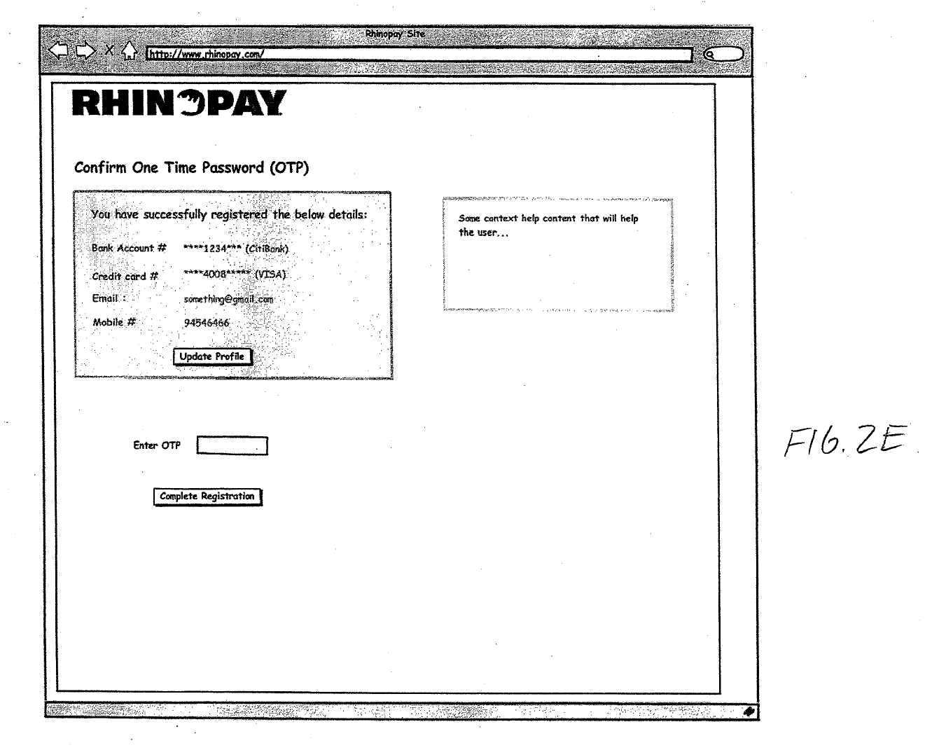

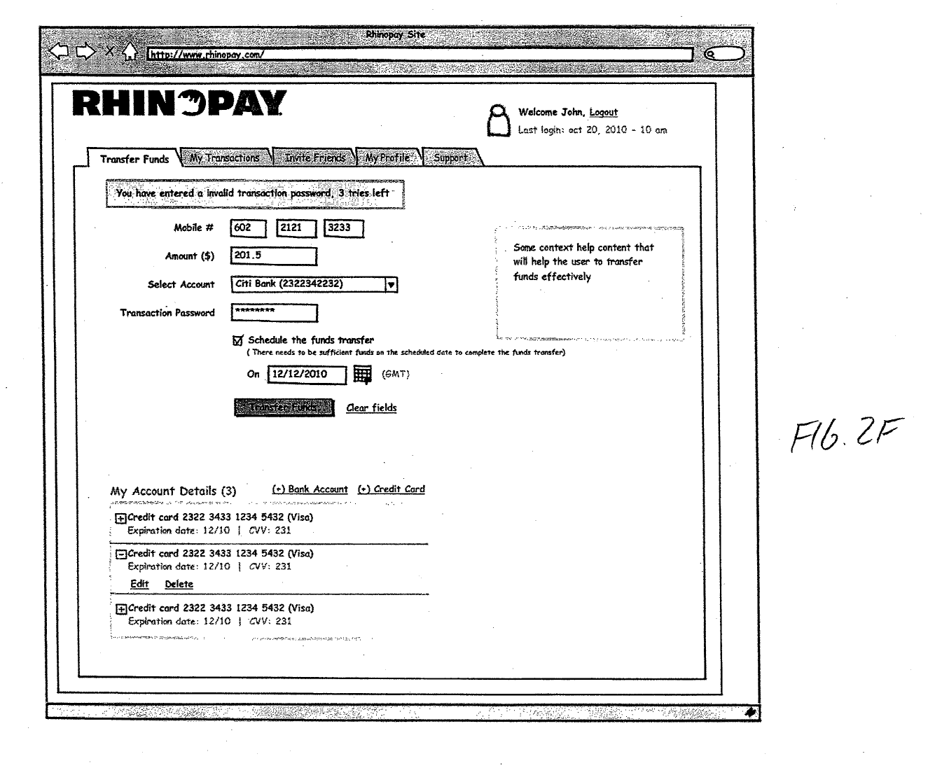

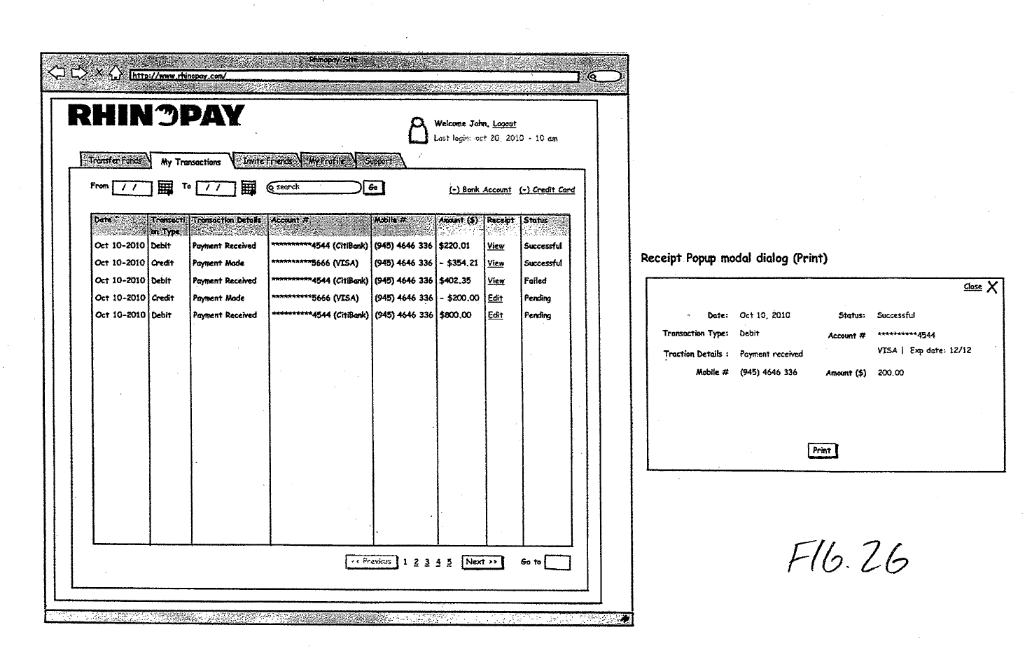

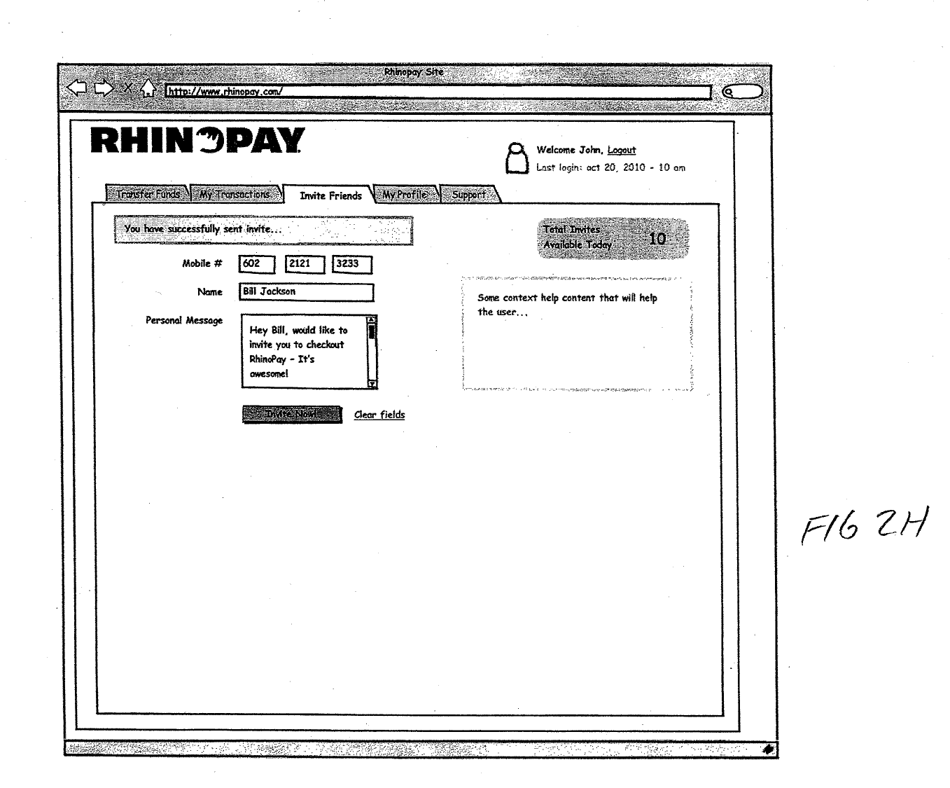

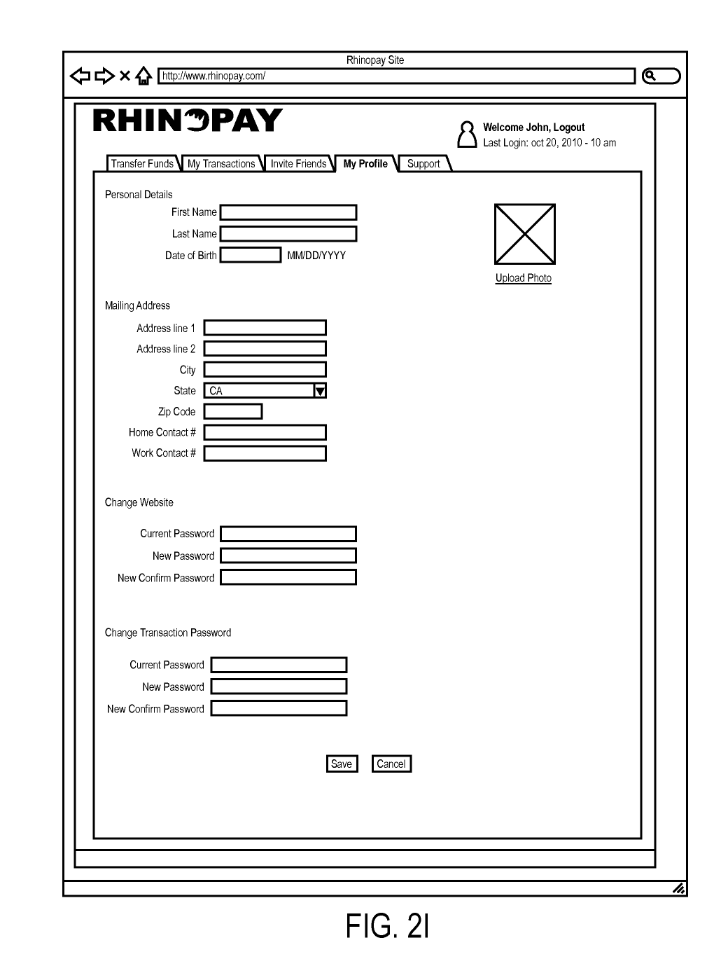

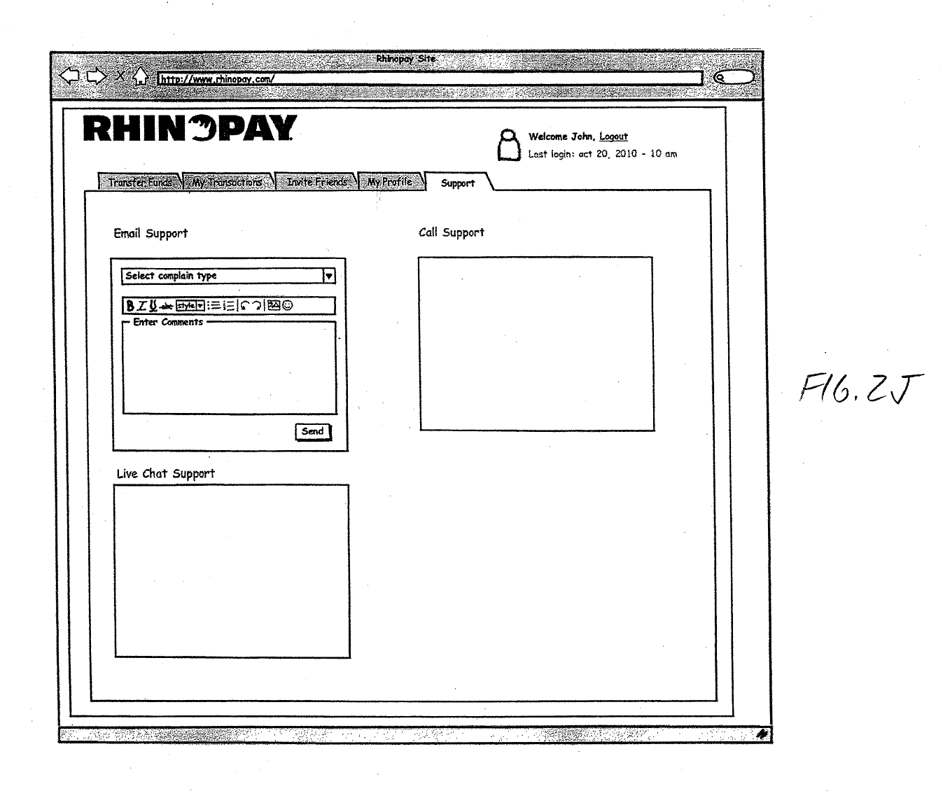

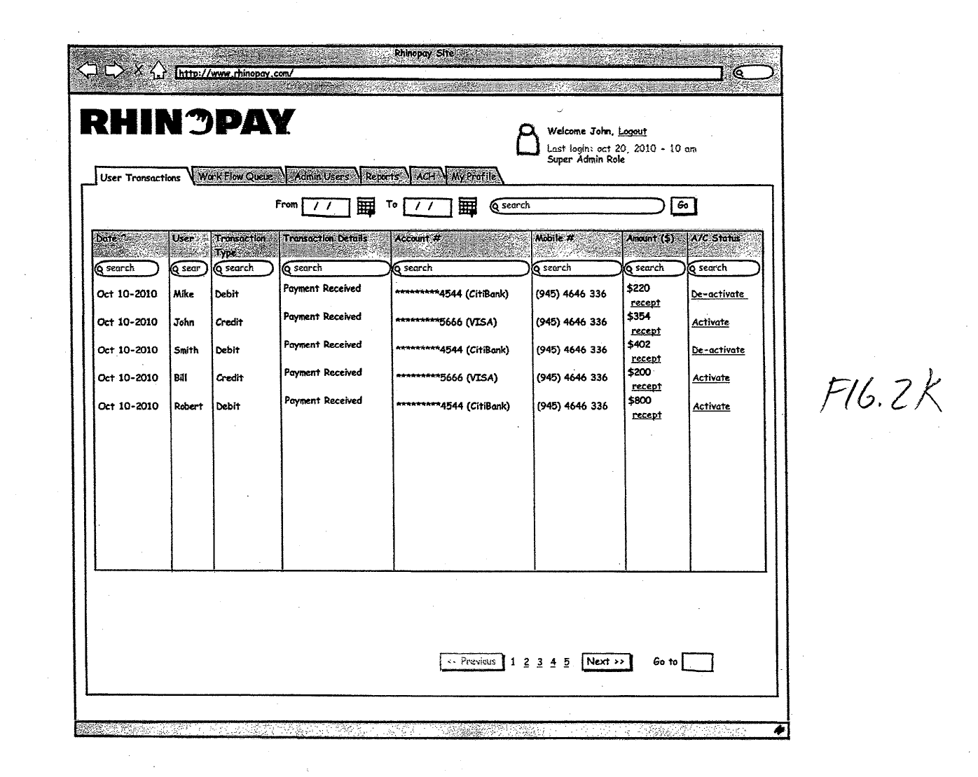

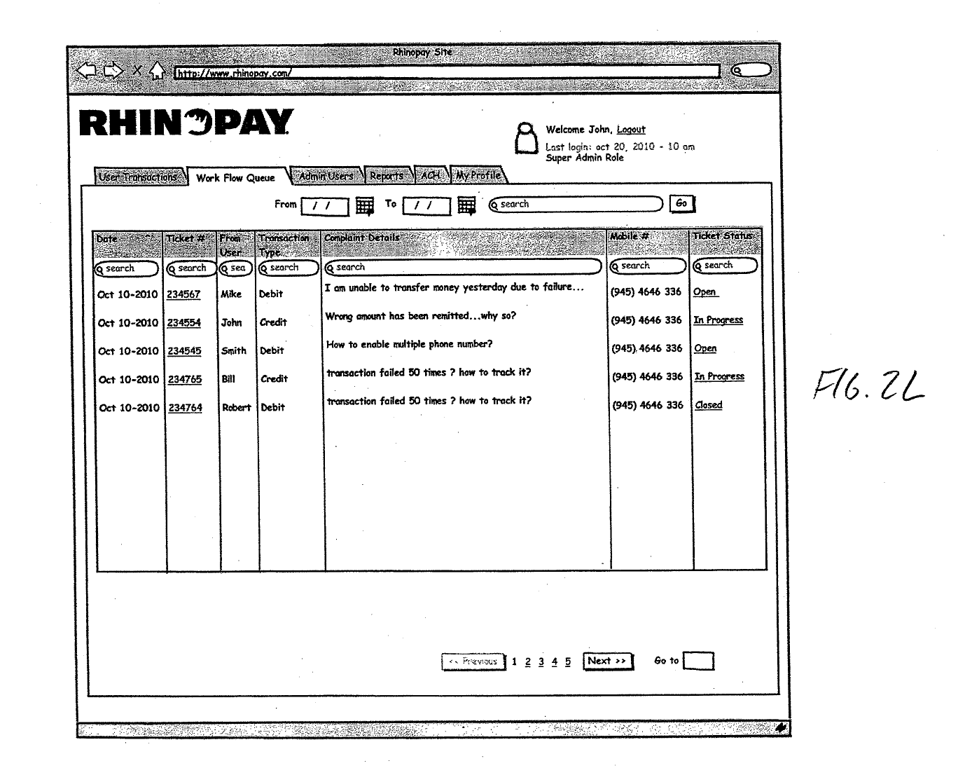

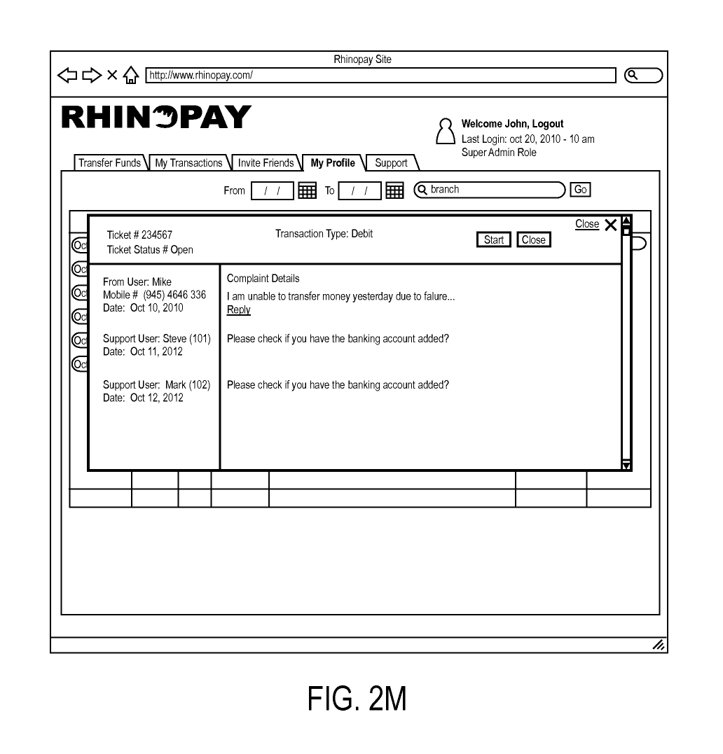

FIGS. 2A-2M show exemplary graphical user interface (GUI) objects for performing various functions with the mobile payment system 100, such as sign-up, entering bank details, transferring funds, and technical support. The GUI objects can be generated by a server and provided to user either via the Web to a computer or to their mobile devices via a wireless network in HTTPS format.

P2P Banking

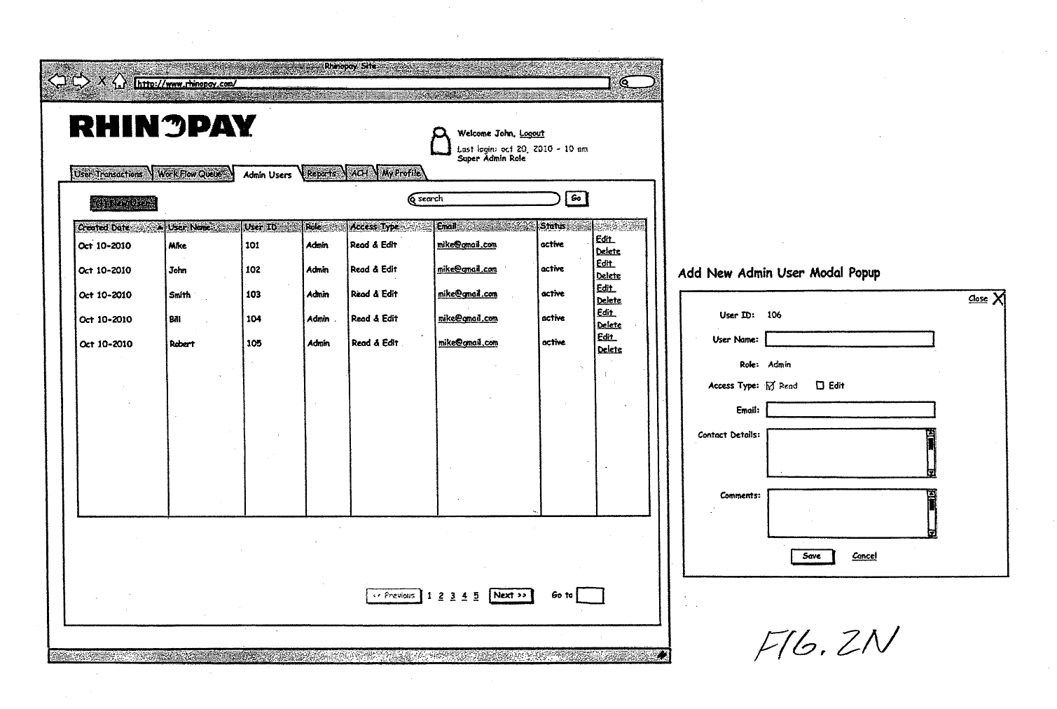

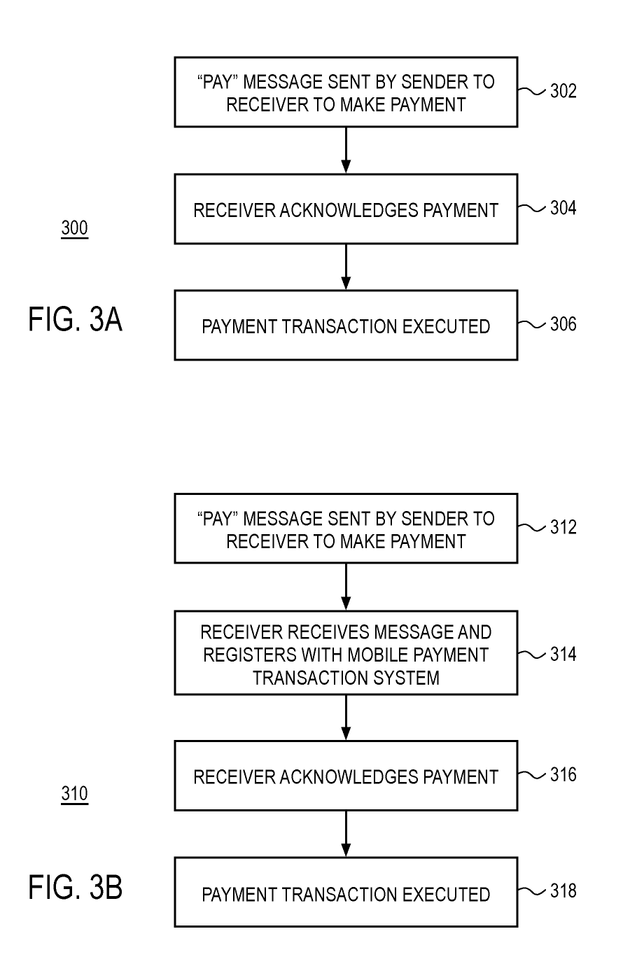

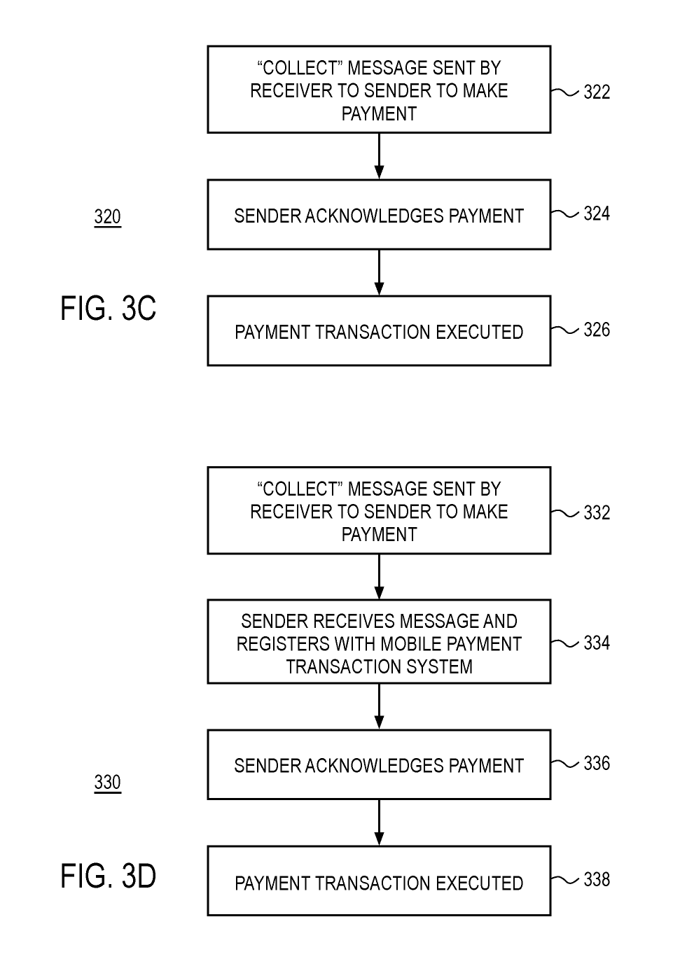

FIGS. 3A-3B represent methods for executing a person-to-person (P2P) mobile payment transaction. FIG. 3B is a flowchart of a method 300 for a mobile payment transaction where both a sender and receiver are registered with the mobile payment system 100. At 302, a user of a sender device creates an SMS message. The SMS message includes a short code designator that addresses and activates the payment processing system of the mobile payment system. The SMS message also includes a mobile device identifier (i.e. phone number) of a receiver device associated with a recipient of the payment. At 304, the receiver receives the SMS text message at the receiver device, and meanwhile, at 306 the payment transaction is executed by the payment processing system. This transaction includes encrypting/decrypting the SMS message from the user, translating the user message to a processor format, transmitting the message using HTTPS (SSL) to the transaction processor, authenticating the users of the sender and receiver devices, and then debiting a bank account of the sender while crediting a bank account of the receiver. In some implementations, the receiver need not take any action other than receiving the SMS notification of the credit. In other implementations, the receiver needs to actively “accept” payment by the sender by pushing a button on the mobile device, sending a reply message (which can activate step 306), or other action.

FIG. 3B is a flowchart of a method 310 for a mobile payment transaction where the sender is registered with the mobile payment system 100, but the receiver is not. As with the method 300, at 312 a user of a sender device creates and transmits an SMS message, to activate the payment processing system and authenticates the receiver as not a user. At 314, the receiver receives the SMS message. The payment processing system recognizes that the receiver is not a registered user of the mobile payment system, and therefore initiates an invitation of the receiver user to register with the system through a registration program, by which the receiver user can enter identification and verification information, bank account information, and other preferences and registration information. Once registered, at 316 the user acknowledges the SMS message and the requested payment by the sender. At 318, the payment transaction is executed by the payment processing system.

FIG. 3C is a flowchart of a method 320 in which a recipient of a payment initiates a request to a sender of the payment, and where both the receiver and the sender are registered with the mobile payment system 100. At 322, a receiver creates an SMS message with a designator of “collect,” an amount of the payment, and the mobile device number of the desired payor or sender. At 324 the sender of the payment acknowledges the SMS request for payment, and at 326 the payment transaction is executed, i.e. the payment processing system debits the bank account of the sender and credits the bank account of the receiver of the payment amount.

FIG. 3D is a flowchart of a method 330 for a mobile payment transaction where the receiver is registered with the mobile payment system 100, but the sender is not. At 332 a receiver creates and transmits an SMS message as described above with respect to FIG. 3C. The designated sender of the payment receives the message at 334, and in order to enable execution of the payment, must be registered with the system. Accordingly, the sender user, if recognized by the payment processing system as not being a registered user, is presented with a method for registering and entering the information described above to become a registered user. Once registered, at 336 the sender acknowledges the SMS request message and the associated requested payment, and at 338 the payment transaction is executed, i.e. the payment processing system debits the bank account of the sender and credits the bank account of the receiver of the payment amount.

Mobile Commerce

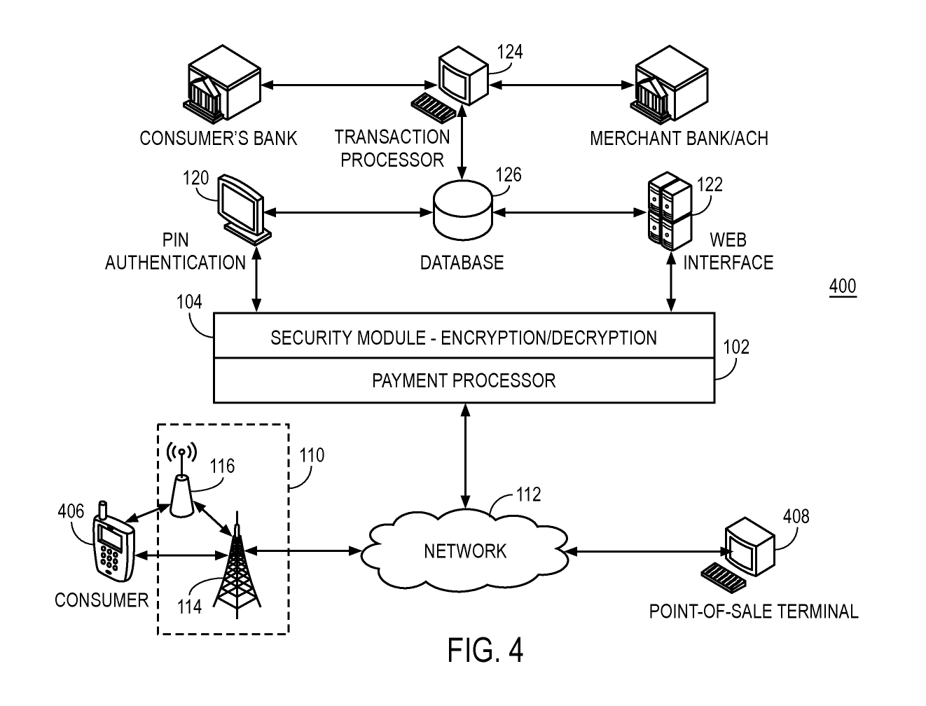

Consumers can send and receive money via an interactive SMS process while funds are transferred from account to account using a secure proprietary process. FIG. 4 illustrates a mobile commerce system 400 in which a consumer can send or receive money via their mobile device 406 at a point of sale (POS) terminal 408 at a merchant, such as a retailer, a wholesaler, or any other provider or seller of goods or services. Alternatively, the POS terminal 408 can also represent an e-commerce website that a consumer can visit and, having already registered as a user with the mobile commerce system 400, including identification via their mobile device 406 number, the consumer can instantly approve payment for a good or service using the mobile commerce system 400. In still other implementations, the POS terminal 408 can be a gasoline pump at a gas station, a product or food dispenser, or other fixed or mobile terminal.

The mobile commerce system 400 includes a payment processing system 102 that includes payment processing software and logic and communication interfaces for executing electronic payment transactions. The payment processing system 102 provides a number of application programming interfaces (APIs) and logic modules for receiving messages from a network 104 and, based on the content of the messages, executing a payment transaction between a consumer 406 and the POS terminal 408. As noted above, the POS terminal 408 can be a networked cash register, a computer terminal or a website displayed by a browser on a computer. The POS terminal 408 can include a credit card processing terminal, such as a card “swiper” or reader, and may even include a barcode scanner and interactive display monitor.

The consumer 406 may make purchases using their mobile device. In some implementations, a consumer 406 can create an SMS text “payment” message with a number representing the POS terminal 408 and/or merchant, and an amount to be transferred from the consumer's bank account to the account associated with the merchant. Alternatively, the consumer 406 can obtain a “closed network” transaction card that can be pre-loaded with funds from the consumer's bank account via use of the mobile commerce system 400. By using the transaction card at the POS terminal 408, the consumer 406 can avoid credit card transaction and/or processing fees or charges.

In still yet another implementation, the POS terminal 408 can also be a television displaying a direct response program. The direct response program can display a code to represent a product. The code can represent the identification of a product, the product price, etc. The code can be a bar code or other graphical code that can be scanned by the user's mobile device, deciphered by a local application or by the payment processor system 102, and used to make the desired transaction.

Similar to the system illustrated in FIG. 1, the payment processing system 102 is connected with a security module 104 that performs encryption and decryption of messages between the consumer 406, merchant 408 and the rest of the mobile payment system 100. The security module 104 may be hosted on a server connected with the network 112, or may be a local application or function on the consumer 406 and/or merchant 408, or both. Preferably, the messages sent by the consumer 406 are SMS messages, and the security module 104 is associated with a local application on the mobile device of the consumer 406 to encrypt the SMS messages so that the content of the messages are not viewable by an unauthorized user of the consumer's 406 mobile device.

The mobile commerce system 400 further includes a PIN authenticator 120, which authenticates any PINS that are entered by registered users of the payment processing system 102, and acting as either a sender of a payment or a receiver of credit or refund, for instance. The consumer 406 needs to identify themselves and provide authentication of their identity. The PIN authenticator 120 can be a computer or a software module running on a computer. The mobile commerce system 400 also includes a web interface 122 for communicating with the Web 112. The web interface 122 provides, among other functions, a web page from which users can register themselves to use the mobile commerce system 400, or communicate with other potential users, or with any other component of the mobile payment system 100. The web interface 122 can be implemented as a server computer, either in hardware or software, and is adapted for hypertext transfer protocol (HTTP or HTTPS) communications. The web interface 122 can also provide a shopping cart module to any website, which provides functionality to enable a consumer 406 to use the mobile commerce system 400 to transact payments, as opposed to other payment methods such as debit or credit cards.

The mobile payment system 100 further includes a transaction processor 124, which executes the payment transaction between financial institutions, such as a sender bank and a receiver bank, associated with both the sender 106 and the receiver 108 of a payment, respectively. The transaction processor 124 can include, without limitation, an automated clearing house (ACH) function or network interface to execute electronic debit and credit payment transactions, such as electronic funds transfers (EFTs) or electronic bill payments (EBPs), represented by the messages between the sender 106 and the receiver 108.

The PIN authenticator 120, Web interface 122 and transaction processor 124 are connected to a database 126, which stores registration data for each user of the mobile payment system 100, as well as transaction data for each mobile payment transaction executed by the payment processor 102. The database 126 can also store a history of messages between the sender 106 and receiver 108, whether or not related to a payment transaction. For instance, a receiver 108 may request payment from a sender 106 via a SMS message sent to the sender 106, and the sender 106 may decline the request via a reply SMS message. These messages between the receiver 108 and the sender 106 can be stored in the database 126 as a record of communication regarding the requested transaction.

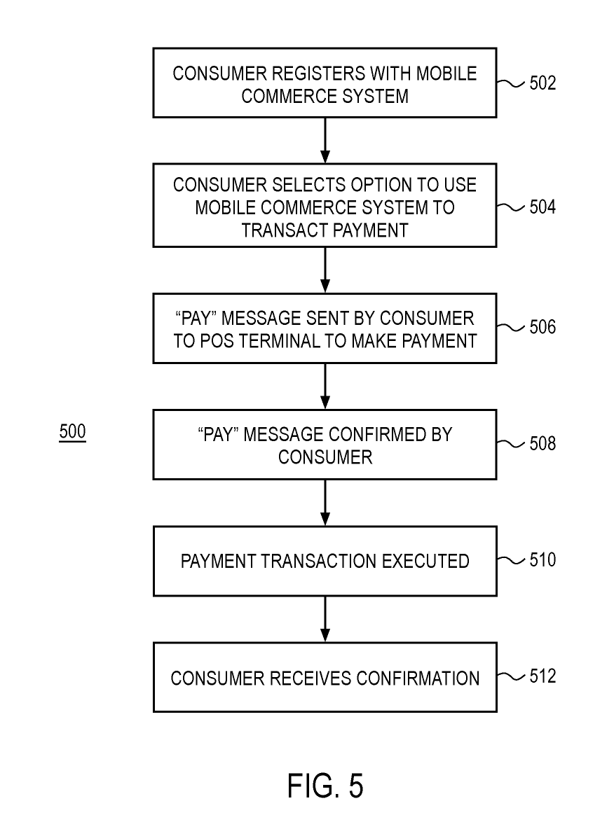

FIG. 5 is a flowchart 500 of a mobile commerce method, executed on a mobile device. At 502, a consumer registers with a mobile commerce system. At 504, the consumer selects an option, via an application on their mobile device, to use the mobile commerce system to transact a payment, and at 506 a “pay” message is sent by the consumer, via their mobile device to a point of sale (POS) terminal, to make a payment from the consumer's account to an account associated with the POS terminal. At 508, the “pay” message is confirmed by the consumer, and at 510 a requested payment transaction is executed. At 512, the mobile device receives a confirmation of the transaction, and can display the confirmation via a graphical user interface to the consumer.

Mobile Remittance

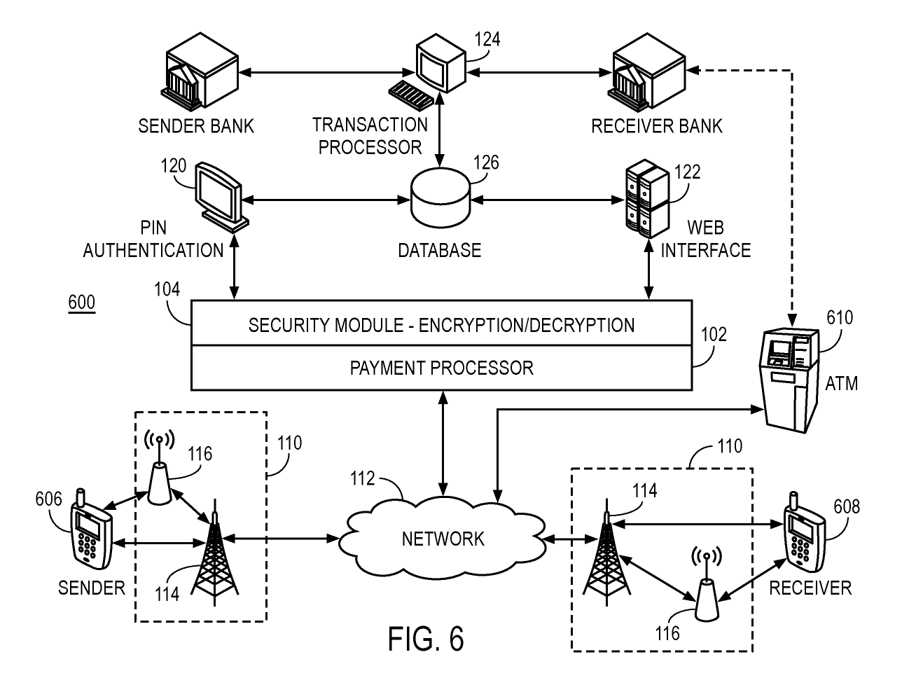

FIG. 6 is a block diagram of a mobile remittance system 600, in which a sender 606 can send a payment message to a receiver 608, which message also enables an automated teller machine (ATM) 610 of similar cash dispensing device to dispense the payment in cash to the receiver 608.

The mobile remittance system 600 includes the payment processor 102, security module 104, PIN authenticator 120, Web interface 122, transaction processor 124 and database 126 as substantially described above with respect to systems 100 and 400. However, the mobile remittance system 600 further includes extra security modules, implemented either by the transaction processor 124, the security module 104, or the payment processing system 102, or distributed among all of those parts of the system 600. The extra security modules include, without limitation, currency exchange controls, cross-border governmental fee processing, inter-bank processing, and other logic that may be needed, particularly if the mobile remittance transaction crosses national borders.

Mobile Giving

The systems and methods described herein can also be used to enable mobile device users to send payments to their favorite charities or causes. The charity registers as a receiver, and the user can send a message containing the receiver's number, amount to give, and the special short code to effect the transaction.

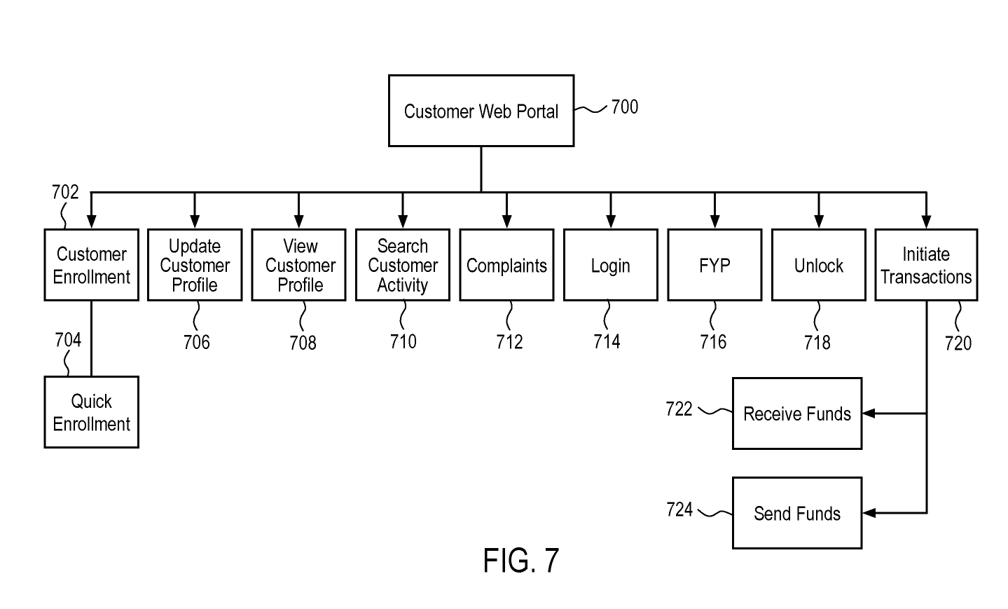

FIG. 7 is a block diagram of a customer web portal (CWP) 700. The CWP 700 includes a customer enrollment module 702 for executing a method for enrolling a customer in the mobile payment system and establishing a customer profile. The customer enrollment module also includes a quick enrollment module 704. The CWP 700 further includes an update customer profile module 706 by which changes or updates to the customer's profile data can be made. A view customer profile module 708 provides a visual representation of the customer's profile data. A search customer activity module 710 allows a customer to search their transaction history for specific transaction activities. The CWP 700 also includes a complaint module 712, a fix your password (FYP) module 714, an unlock module 716, and an initiate transaction module 718. The initiate transaction module 718 starts a transaction to be executed, including transactions to receive funds 720 or to send funds 722, as described herein.

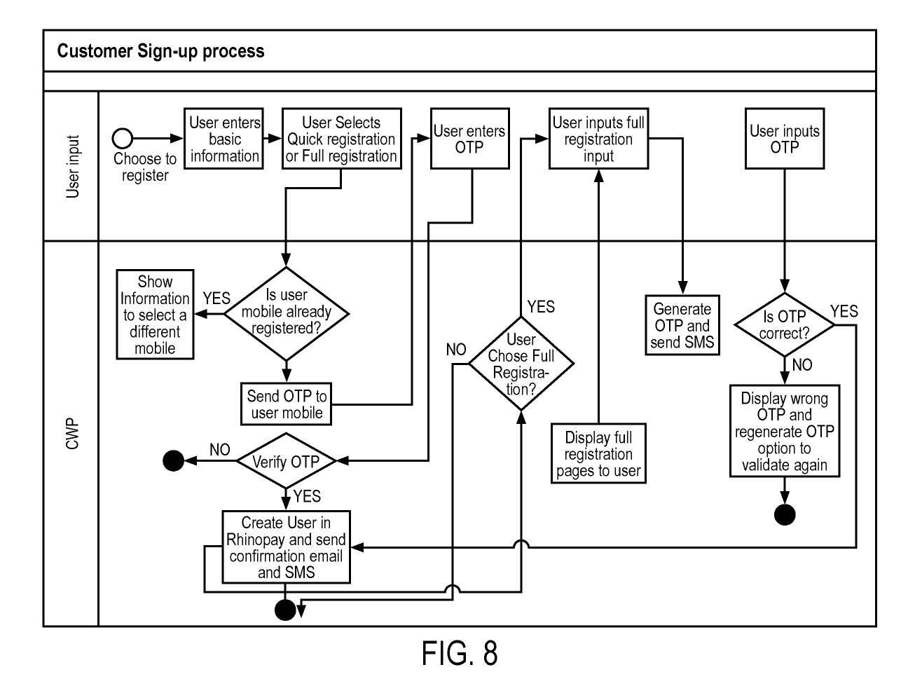

FIG. 8 illustrates a customer sign-up process, explained in further detail in the following table:

| | Step |
|---|---|
| 801 | User chooses to register for the Rhinopay online portal. |
| 802 | User clicks on the online registration link |
| 803 | User starts giving inputs for the following fields. |
| | Given name (First name) |
| | Last name |
| | Date of birth |
| | Email address |
| | Mobile number (user will login with this mobile number as user id) |
| | Re-enter mobile number. |
| | Login password |
| | Re-enter login password. |
| | User can choose to do quick registration or full registration. In either cases, |
| | CWP verifies if the mobile is already registered or not. If registered, user is |
| | informed that the mobile number is already registered and input with a |
| | different mobile number. |
| | CWP then sends an OTP to user. |
| | This is required to confirm the user mobile number. |
| | The OTP is sent as SMS to the mobile registered. |
| | User enters the OTP and verifies his identity. |
| | If the user does not enter the correct OTP three times, the user has to |
| | contact the support team. There is an option to regenerate OTP for four |
| | times. |
| | User is communicated on successful quick registration through email and |
| | SMS. |
| | If the user chooses full registration, all other necessary data is collected in |
| | successive steps. |
| 804 | Terms and Conditions content to be displayed for the user to read and |
| | agree or disagree. |
| | The user is advised through a message pop-up to scroll through entire |
| | “terms and conditions” text area. |
| | Unless the user scrolls through the entire length of T&Cs “I agree” and “I |
| | disagree” radio buttons stay in disabled mode. |
| | The user clicks on “I agree” or “I disagree” radio button. |
| | If the user chooses “I disagree” a message up to inform that the user |
| | cannot proceed with registration without agreeing the terms and |
| | conditions. |
| 805 | User enters the below information in the page2 of full registration. |
| | User provides |
| | a) Billing information |
| | Address line 1 |
| | Address line 2 |
| | City |
| | State |
| | Zip code |
| | b) Selects Account Information Type x Bank Account, x Credit card |
| | Appropriate information is populated based on the selection of account |
| | type. |
| | By default the user is shown Bank account information fields, |
| | If Bank account is selected, user enters below information |
| | Bank name |
| | Bank account number (characters are all viewable to customer) |
| | Re-enter bank account number |
| | Routing number (characters are all viewable to customer) |
| | Re-enter routing number |
| | State <drop down of US> |
| | Bank account billing address: check box to use mailing information |
| | provided above (a) |
| | If the user selects Credit card, user enters below information. |
| | Credit card type (drop down) |
| | Visa |
| | MasterCard |
| | American Express |
| | Discover |
| | Credit card number (characters are all viewable to customer) |
| | CVV (Security) number |
| | Expiration Date |
| | Credit card mailing address: check box to use mailing information |
| | provided above (a) |
| | User selects next button to move to another set of inputs. |
| 806 | User enters the below information. |
| | Transaction PIN |
| | Re-enter Transaction PIN |
| | All passwords are masked with asterisk symbols. |
| | The password strength is captured in Appendix A. |
| | Three security questions are asked to select from a list of 10 questions |
| | (from questions super set - captured in Appendix) and input answers to |
| | them. |
| | 10 Questions in drop down for three select boxes. |
| | 3 answers in text boxes. |
| | User selects next button to move to another set of inputs required for |
| | registration. |
| 807 | The next page of the registration shows the summary of information |
| | captured for all the previous pages and a confirmation is taken. The |
| | registration data is submitted to database and the status of the user |
| | registration is marked as “Not verified”. The credit card and bank account |
| | numbers are masked and only last four digits are shown. |
| | CWP sends an OTP to the registered mobile number as SMS message. The |
| | user is shown a screen to input the OTP received on his mobile. |
| 808 | User inputs the OTP received on his mobile. The application validates this |
| | information and if found valid and correct, the user registration status is |
| | changed to “verified.” An SMS and email is sent to user informing |
| | successful registration verification. |
| | If the user does not verify correctly for three consecutive times, the user |
| | account is blocked to perform any registration related actions (OTP |
| | verification, update profile etc). |
| | The user can unblock by answering the security questions and proceed for |
| | account verification (OTP is regenerated and an SMS is sent to user). |
| | If the user does not receive the OTP SMS because of carrier network |
| | failure or any other issue, he/she can regenerate it. |
| | If the user does not receive SMS; he can opt to regenerate the OTP using |
| | the button provided on the OTP verification page. Limit for the number of |
| | times the user can regenerate OTP is four (4) times. |
| | Each OTP input from user will allow three attempts to verify. And each |
| | OTP generated is unique and random. |
| | If the user does not verify his registration for seven days, his account is |
| | blocked to perform any registration related actions. The user can unblock |
| | by answering the security questions. |
| | If the user has forgotten his security questions or has answered incorrectly |
| | for three attempts his account is locked (The user cannot login to |
| | website). To unlock the account, the user has to contact customer support. |

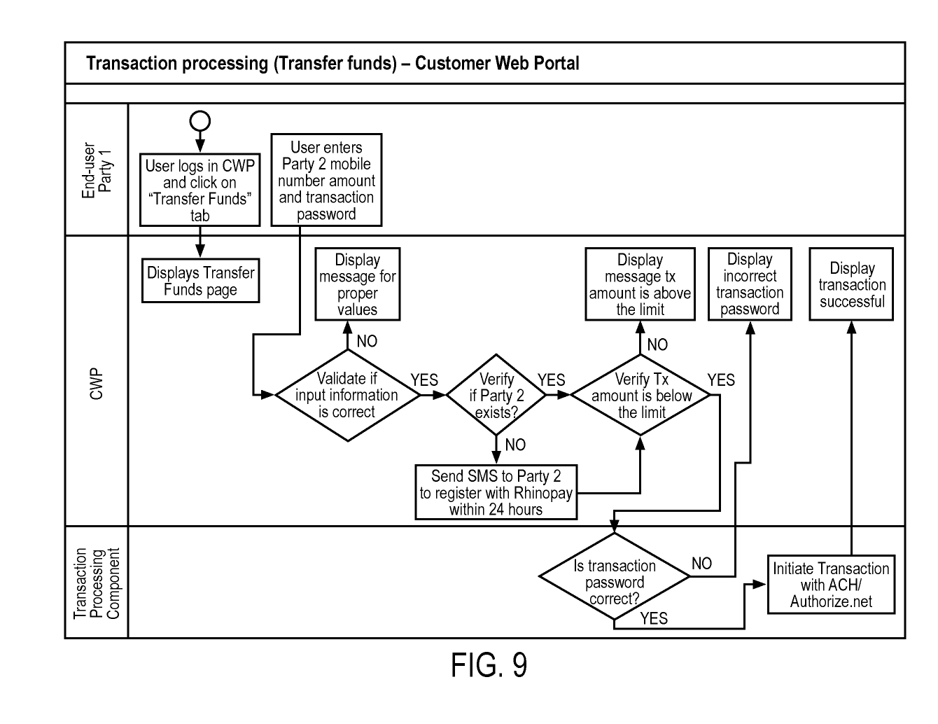

FIG. 9 illustrates a transaction processing method, explained in further detail in the following table. The participating user (party 1) who initiates the transaction should be registered with the system. Party 2 will only receive a Successful Transaction SMS

Step

Party 1 starts the transaction by sending an SMS to the short code for the
system.
An example is: PAY 6021472222 (Mobile Number) 57.68 (amount)
Server receives the message and performs the following:
Check the message for the right format
Verify the sender is a registered user.
Verify the destination number, Party 2, is a registered customer
If party 2 is not registered, the system will continue to take further
information required for the transaction and put the transaction in
pending status. A SMS is sent to Party 2 informing that Party 1 is
trying to send funds and he/she has to register with the system
within 24 hours to receive them.
If the Party 2 does not register in 24 hours duration, the transaction is
nullified and an SMS is sent to Party 1 informing that Party 2 has not
registered and hence cannot proceed with fund transfer.
The system checks if the fund transfer amount is in the limit allowed and
also below the maximum number of allowed transactions per month. If
either of them fail, an SMS is sent informing the same.
If both limits are satisfied, the system sends SMS request to debit funds
from which account on record the fund transfer debit should happen.
A user may hold more than one bank account with the same bank.
Transaction processing component generates random index numbers
(jumbled sequence) of the transaction password of Party 1 and sends
an SMS to Party 1 requesting to reply back with the password characters
of these indexes.
The system verifies the password input and confirms his/her authentication
for the fund transfer.
If the verification fails, the system computes another set of indexes for the
password and sends an SMS.
If the user has used all three attempts to authorize with right password
value, the user account of Party 1 is blocked. He cannot perform any
transactions until the user account is unblocked. To unblock the account,
the user has to enter correct answer to a security question.
On successful authentication, fund transfer takes place with the set of fees
deduction rules applied and an SMS is sent to both “party 1 and party 2”
that the transaction has been successful.
If there are any issues while doing the fund transfer such as no balance,
account inactive or closed etc. An SMS is sent to both parties informing
the same.

If Party 1 and Party 2 are currently enrolled customers with the service:

Step

Party 1 starts the transaction by sending an SMS to the short code for the
system.
An example is: GET 6021472222 (Mobile Number) 57.68 (amount)
The Server receives the message and performs the following
Check the message for the right format
Verify the sender is a registered user.
Verify the destination number, Party 2, is a registered customer
If party 2 is not registered, the system will continue to take further
information required for the transaction and put the transaction in
pending status. A SMS is sent to Party 2 informing that Party 1 is
trying to request funds and he/she has to register with Rhinopay
within 24 hours to pay them.
If the Party 2 does not register in 24 hours duration, the transaction is
nullified and an SMS is sent to Party 1 informing that Party 2 has not
registered and hence cannot proceed with the requesting funds.
The system checks if the fund transfer amount is in the limit allowed and
also below the maximum number of allowed transactions per month. If
either of them fail, an SMS is sent informing the same.
If both limits are satisfied, the system sends SMS to Party 2 confirming
transaction information, number & amount, and at this time confirms
to debit funds from default account on file.
A user may hold more than one bank account with the same bank.
Transaction processing component generates random index numbers
(jumbled sequence) of the transaction password of Party 1 and sends
an SMS to Party 1 requesting to reply back with the password characters
of these indexes.
The system verifies the password input and confirms his/her authentication
for the fund transfer.
If the verification fails, the system computes another set of indexes for the
password and sends an SMS.
If the user has used all three attempts to authorize with right password
value, the user account of Party 1 is blocked. He cannot perform any
transactions until the user account is unblocked. To unblock the account,
the user has to enter correct answer to a security question.
On successful authentication, fund transfer takes place with the set of
fees deduction rules applied and an SMS is sent to both “party 1
and party 2” that the transaction has been successful.
If there are any issues while doing the fund transfer such as no balance,
account inactive or closed etc. An SMS is sent to both parties informing
the same.

Success Outcome: The amount transfer transaction initiated by Party1 is successful and the accounts of party1 and party2 are debited and credited respectively. Failure Outcome If the SMS transaction verification fails ‘3’ times, the account of Party1 is locked. If the SMS transaction session outs, the user transaction is nullified.

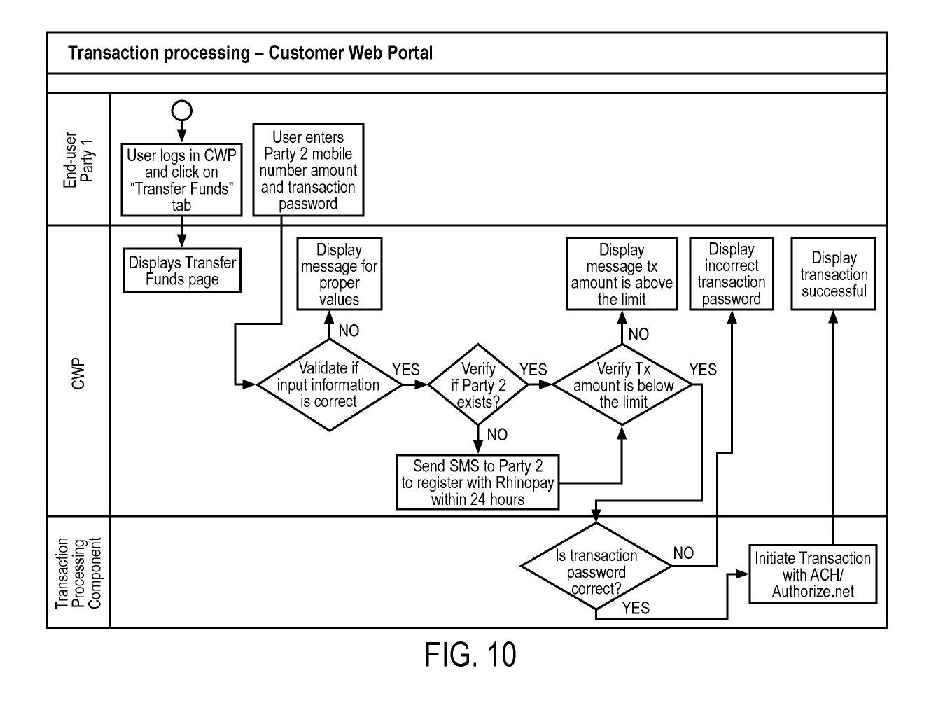

FIG. 10 illustrates another transaction processing method to transfer funds between two parties through the CWP, explained in further detail in the following table.

Process Step

User chooses to do fund transfer. User selects the “Transfer funds” tab
CWP displays the transfer funds page which contains fields that are
required for a fund transfer. The fields are mobile number, amount of the
fund receiver, select account (from which debit should happen) and
transaction password.
If party 2 (fund receiver) is not registered a SMS is sent to Party 2 to
register within 24 hours. If Party 2 registers within 24 hours the
transaction is completed normally. If the party 2 does not register in this
time, the transaction is nullified and an SMS is sent to party 1 informing
that party 2 has not registered in the stipulated time.
User enters the above information in this page and click on transfer funds.
Transaction processing component verifies if the password is correct and
the amount is in the transaction limit.
If the password is not correct, CWP display the error message. If the user
enters
Wrong password for consecutive three times the user account is blocked
for any further transactions.
To unblock his account the user has to answer the security question.
Although the user account is blocked he can still receive funds.
If the password is correct, transaction processing component contacts Pivot
ACH
And authorize.net to perform necessary transactions between user account
and
Rhinopay merchant account. The details are documented in Appendix.
CWP display a transaction successful message and an email/SMS is sent to
user account.

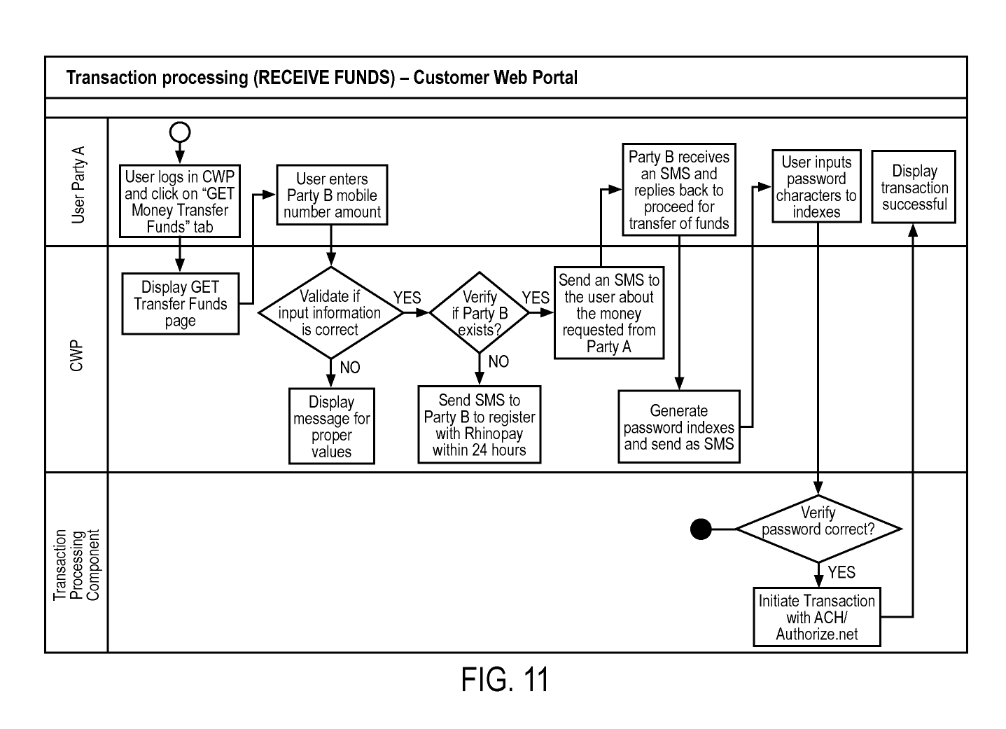

FIG. 11 illustrates another transaction processing method to receive funds by one party, explained in further detail in the following table.

Process Step

User chooses to do fund transfer. The user selects the “Transfer funds” tab
CWP displays the transfer funds page which contains fields that are
required for a fund transfer. The fields are mobile number, amount of the
fund to request, select account (from which credit should happen if
different than default) and transaction password.
If party 2 (payor) is not registered a SMS is sent to Party 2 to register
within 24 hours. If Party 2 registers within 24 hours the transaction is
completed normally. If the party 2 does not register in this time, the
transaction is nullified and an SMS is sent to party 1 informing that party
2 has not registered in the stipulated time.
User enters the above information in this page and click on “receive
funds”.
The system sends an SMS to the party B (payor). The party B may choose
to reply back with SMS confirming his intention to pay the requested
funds.
The party B may choose to login CWP and choose the pay request from
the message tray and transfer the funds.
In case of paying through SMS or in CWP, the system requests for
transaction password. Transaction processing component verifies if the
password is correct
If the password is not correct, CWP display the error message. If the user
enters
Wrong password for consecutive three times the user account is blocked
for any further transactions.
To unblock his account the user has to answer the security question.
Although the user account is blocked he can still receive funds.
If the password is correct, transaction processing component contacts Pivot
ACH
And authorize.net to perform necessary transactions between user account
and system merchant account.
CWP display a transaction successful message and an email/SMS is sent to
user account.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A mobile payment method comprising:
receiving a message from a first mobile device, the message including a payment code, an amount of a payment, and a receiver designator representing a receiver of the payment;
receiving a confirmation message from the receiver of the payment;
debiting, from a first account associated with the first mobile device, an amount of the payment and a fee; and
crediting a second account associated with the receiver of the payment the amount of the payment.

2. The mobile payment method in accordance with claim 1, wherein the message is a text message.

3. The mobile payment method in accordance with claim 2, wherein the text message is formatted according to a short messaging service protocol.

4. A mobile payment method comprising:
generating a message by a first mobile device, the message including a payment code, an amount of a payment, and a receiver designator representing a receiver of the payment;
transmitting the message from the first mobile device to a server via a communications network, the server communicating with the receiver of the payment for confirmation;
receiving, by the first mobile device, a confirmation message from the receiver of the payment;
debiting, from a first account associated with the first mobile device, an amount of the payment and a fee; and
crediting a second account associated with the receiver of the payment the amount of the payment.

5. The mobile payment method in accordance with claim 4, wherein the message is a text message.

6. The mobile payment method in accordance with claim 5, wherein the text message is formatted according to a short messaging service protocol.

7. The mobile payment method in accordance with claim 4, further comprising registering, by the first mobile device, a user of the first mobile device.
